(19) United States
(12) Patent Application Publication
(10) Pub. No.: US 2018/0130140 A1
(43) Pub. Date: May 10, 2018

(54) SOCIAL RELATIONSHIP CHAIN OBTAINING METHOD AND TERMINAL AND STORAGE MEDIUM

(71) Applicants: Dalian Minzu University, Dalian (CN); TENCENT TECHNOLOGY (SHENZHEN) COMPANY LIMITED, Shenzhen (CN)

(72) Inventors: Xiaoke XU, Dalian (CN); Yading YUE, Shenzhen (CN); Peng HE, Shenzhen (CN); Chuan CHEN, Shenzhen (CN); Tingting LIU, Shenzhen (CN); Jia LIU, Dalian (CN)

(21) Appl. No.: 15/861,358

(22) Filed: Jan. 3, 2018

Related U.S. Application Data
(63) Continuation of application No. PCT/CN2016/090081, filed on Jul. 14, 2016.

(30) Foreign Application Priority Data
Aug. 12, 2015 (CN) 201510493378.4

(51) Int. Cl. G06Q 50/00; G06F 17/30; H04L 29/08

(52) U.S. Cl. CPC G06Q 50/01; H04L 67/306; G06F 17/30861

(57) ABSTRACT

Social relationship chain obtaining method and terminal and a readable medium are provided. The method includes: obtaining a target user set and mutual-friend information between any two target users in the target user set, target users in the target user set being friends of a center user, and the mutual-friend information indicating whether the two target users are in a friend relationship; constructing a reference network according to the center user and the mutual-friend information between the any two target users in the target user set, nodes in the reference network being the target users in the target user set, and there being a connection line between two target users in the reference network that are in a friend relationship; and determining, from the target user set according to the reference network, a target user being in a parent-child relationship chain with the center user.

### RELATED APPLICATIONS

This application is a continuation application of PCT Patent Application No. PCT/CN2016/090081, filed on Jul. 14, 2016, which claims priority to Chinese Patent Application No. 201510493378.4, filed with the Chinese Patent Office on Aug. 12, 2015 and entitled “SOCIAL RELATIONSHIP CHAIN OBTAINING METHOD AND APPARATUS”, which is incorporated herein by reference in its entirety.

### FIELD OF THE TECHNOLOGY

The present disclosure generally relates to the communications field, and in particular, relates to a social relationship chain obtaining method and terminal and a readable medium.

### BACKGROUND OF THE DISCLOSURE

With rapid development of mobile Internet technologies in recent years, the online social network has become an important manner in information obtaining, leisure and entertainment, communication, and friend making. As a person often has an increasing number of friends on the social network and more frequently uses the social network. Information propagated on the social network may grow explosively, which requires the social network operator to provide personalized information filtering for users.

Considering importance and impact of parents and children as social network users, it is desirable to use information, indicating that persons are mutual friends in the social network, to identify relationships between some users and their parents or children, and thus to provide a better personalized service for the users, and to provide special services for a more convenient communication between parents and children on the social network.

However, the relationship between parents and children on a social network has to be marked manually by users. In other words, unless a user marks a friend in a social network contact list as parent or child, a parent-child relationship chain cannot be obtained in the social network.

### SUMMARY

One aspect of the present disclosure provides a social relationship chain obtaining method, applied to a terminal including at least a memory and a processor. The method includes obtaining a target user set and mutual-friend information between any two target users in the target user set, target users in the target user set being friends of a center user, and the mutual-friend information indicating whether the two target users are in a friend relationship; constructing a reference network according to the center user and the mutual-friend information between the any two target users in the target user set, nodes in the reference network being the target users in the target user set, and there being a connection line between two target users in the reference network that are in a friend relationship; and determining, from the target user set according to the reference network, a target user being in a parent-child relationship chain with the center user.

Another aspect of the present disclosure provides a social relationship chain obtaining terminal, including a memory, storing program instructions for a social relationship chain obtaining method; and one or more processors, coupled to the memory and, when executing the program instructions, configured for: obtaining a target user set and mutual-friend information between any two target users in the target user set, target users in the target user set being friends of a center user, and the mutual-friend information indicating whether the two target users are in a friend relationship; constructing a reference network according to the center user and the mutual-friend information between the any two target users in the target user set, nodes in the reference network being the target users in the target user set, and there being a connection line between two target users in the reference network that are in a friend relationship; and determining, from the target user set according to the reference network, a target user being in a parent-child relationship chain with the center user.

Another aspect of the present disclosure provides a non-transitory computer-readable storage medium, containing computer-executable program instructions for, when executed by a processor, performing a social relationship chain obtaining method. The method includes obtaining a target user set and mutual-friend information between any two target users in the target user set, target users in the target user set being friends of a center user, and the mutual-friend information indicating whether the two target users are in a friend relationship; constructing a reference network according to the center user and the mutual-friend information between the any two target users in the target user set, nodes in the reference network being the target users in the target user set, and there being a connection line between two target users in the reference network that are in a friend relationship; and determining, from the target user set according to the reference network, a target user being in a parent-child relationship chain with the center user.

### BRIEF DESCRIPTION OF THE DRAWINGS

FIG. 1 is a flowchart of an exemplary social relationship chain obtaining method according to some embodiments of the present disclosure;

FIG. 2-1 is a flowchart of an exemplary social relationship chain obtaining method according to some embodiments of the present disclosure;

FIG. 2-2 is a topology view of an exemplary social network according to some embodiments of the present disclosure;

FIG. 2-3 is a topology view of an exemplary reference network according to some embodiments of the present disclosure;

FIG. 2-4 is a topology view of a first subnetwork according to some embodiments of the present disclosure;

FIG. 2-5 is a topology view of a second subnetwork according to some embodiments of the present disclosure;

FIG. 2-6 is a topology view of another second subnetwork according to some embodiments of the present disclosure;

FIG. 3 is a structural diagram of a social relationship chain obtaining apparatus according to some embodiments of the present disclosure; and

FIG. 4 is a structural diagram of a terminal according to some embodiments of the present disclosure.

### DESCRIPTION OF EMBODIMENTS

To make the objectives, technical solutions, and advantages of the present disclosure clearer, the following further describes in detail the embodiments of the present disclosure with reference to the accompanying drawings.

Social relationship chain obtaining method and terminal and storage medium are provided. For example, the social relationship chain may include a parent-child relationship chain.

As disclosed according to various embodiments of the present disclosure, a target user set and mutual-friend information between any two target users in the target user set are obtained; a reference network is constructed according to the center user and the mutual-friend information between the any two target users in the target user set; and a target user, being in a parent-child relationship chain with the center user, is determined from the target user set according to the reference network. As such, even if a user does not mark parent or child information in a contact list, the parent-child relationship chain of the center user can still be identified.

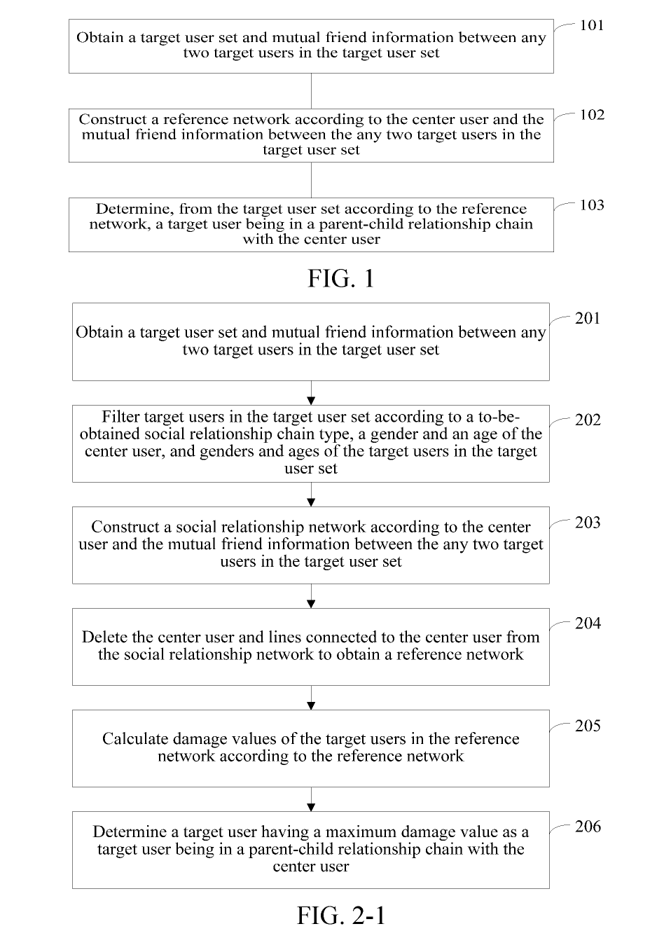

Referring to FIG. 1, an embodiment of the present disclosure provides a social relationship chain obtaining method, including the following exemplary steps.

Step 101. Obtaining a target user set and mutual-friend information between any two target users in the target user set. Target users in the target user set are friends of a center user, and the mutual-friend information is used to indicate whether the two target users are in a friend relationship.

Step 102. Constructing a reference network according to the center user and the mutual-friend information between the any two target users in the target user set. Nodes in the reference network are the target users in the target user set, and there is a connection line between two target users in the reference network that are in a friend relationship.

Step 103. Determining, from the target user set according to the reference network, a target user who is in a parent-child relationship chain with the center user.

In this exemplary embodiment of the present disclosure, a target user set and mutual-friend information between any two target users in the target user set are obtained; a reference network is constructed according to the center user and the mutual-friend information between the any two target users in the target user set; and a target user, being in a parent-child relationship chain with the center user, is determined from the target user set according to the reference network. As such, even if a user does not mark parent or child information in a contact list, the parent-child relationship chain of the center user can still be identified.

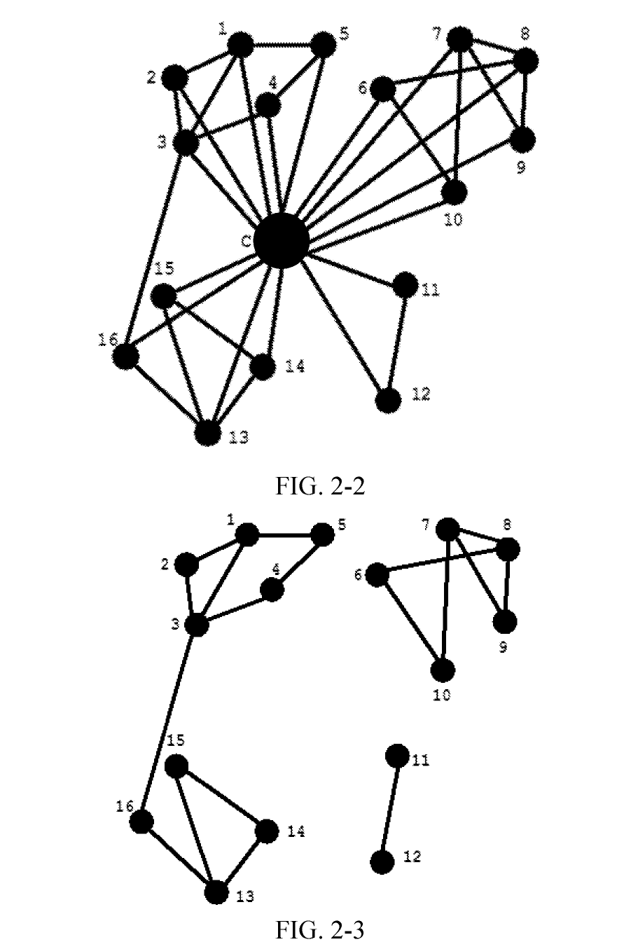

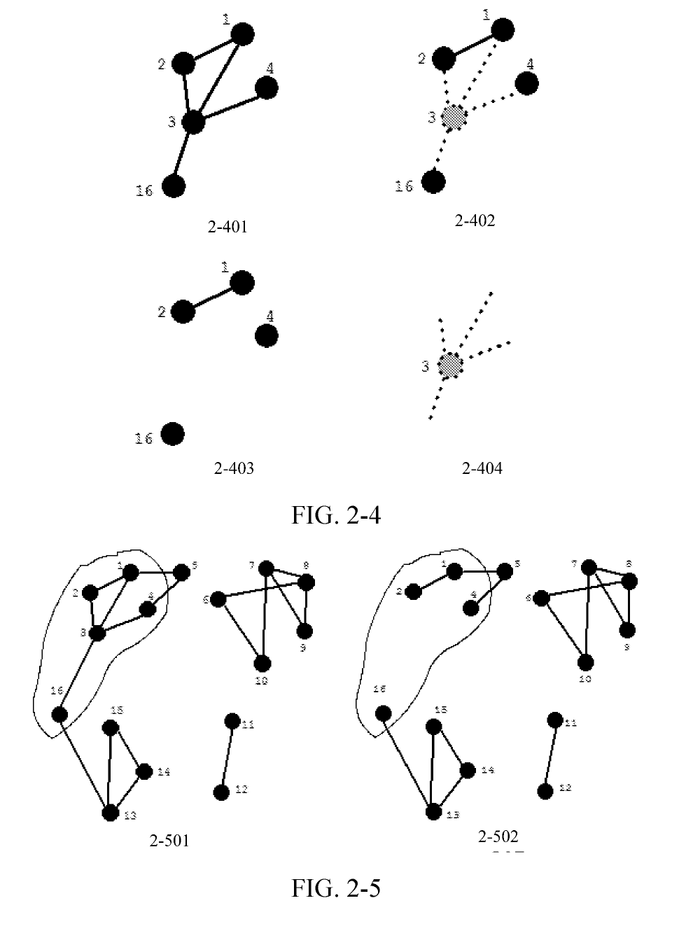

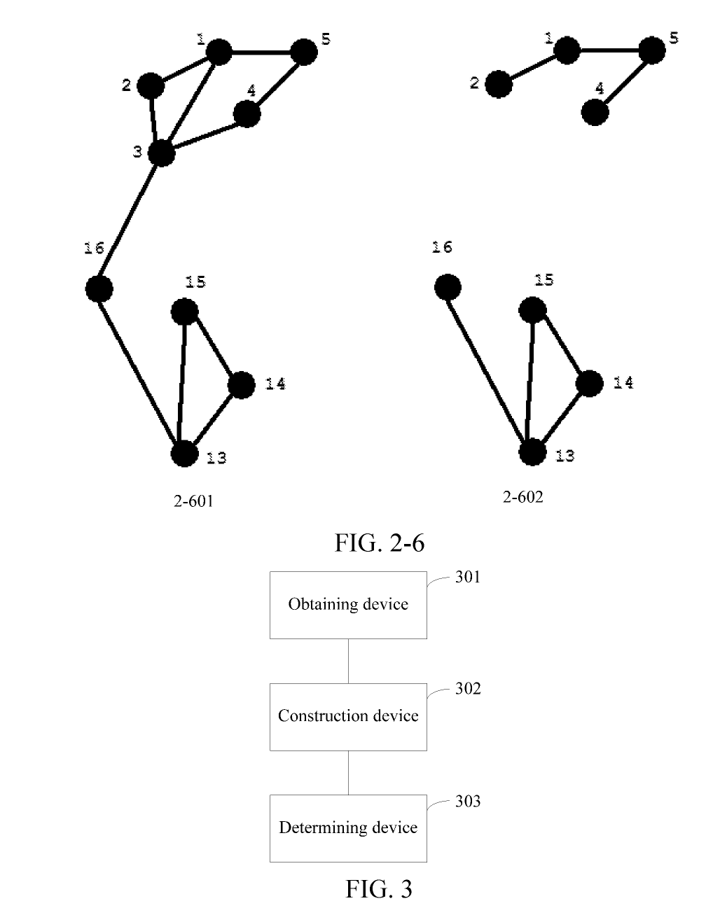

An embodiment of the present disclosure provides a social relationship chain obtaining method. In this exemplary embodiment, a social relationship chain needing to be obtained is a parent-child relationship chain, that is, for a user, referred to as a center user for ease of description, another user who is in a parent-child relationship chain with the center user is obtained by using the method in this exemplary embodiment. Referring to FIG. 2-1, the method includes the following exemplary steps.

Step 201. Obtaining a target user set and mutual-friend information between any two target users in the target user set. Target users in the target user set are friends of the center user, and the mutual-friend information between the any two target users is used to indicate whether the two target users are in a friend relationship.

The target user has user account information in a social network. The user account information includes a contact list, and the contact list includes a friend of the center user in the social network. Similarly, the friend also has user account information in the social network like the center user.

In this exemplary step, user account information of the center user may be obtained from the social network, a contact list of the center user is obtained from the user account information of the center user, and all friends in the contact list are considered as target users to form the target user set. User account information of each target user in the target user set is obtained from the social network, and a contact list of each target user is obtained from the user account information of each target user. For any two target users in the target user set, when a contact list of one of the two target users includes the other target user, mutual-friend information between the two target users is set to be used to indicate that the two target users are in a friend relationship; otherwise, the mutual-friend information between the two target users is set to be used to indicate that the two target users are not in a friend relationship.

Further, a gender and an age of the center user are further obtained from the social network, and a gender and an age of each target user in the target user set are obtained.

The user account information of the center user further saves attribute information of the user. The attribute information is set when the center user registers a user account with the social network, and the attribute information may include a gender, an age, a province, a city, and the like. Similarly, the user account information of each target user in the target user set also saves attribute information of each target user.

Correspondingly, the gender and age of the center user may be obtained from the user account information of the center user, and the gender and age of each target user may be obtained from the user account information of each target user.

For example, it is assumed that the center user is a user C. User account information of the center user C is obtained from the social network, a contact list of the center user C is obtained from the user account information, the contact list includes friends of the center user C: friends 1, 2, 3, 4, . . . , and 16, the friends 1, 2, 3, 4, . . . , and 16 are obtained from the contact list, and the friends 1, 2, 3, 4, . . . , and 16 as are considered as target users to form a target user set.

An age and a gender of the center user C are further obtained from the user account information of the center user C. It is assumed that the obtained age of the center user C is 40, and the obtained gender is female. Similarly, genders and ages of the target users 1, 2, 3, 4, . . . , and 16 are further obtained, as shown in Table 1.

TABLE 1

| Target user | Age | Gender |
|---|---|---|
| 1 | 32 | Female |
| 2 | 16 | Male |
| 3 | 15 | Male |
| 4 | 39 | Male |
| 5 | 31 | Female |
| 6 | 41 | Female |
| 7 | 33 | Male |
| 8 | 14 | Male |
| 9 | 50 | Male |
| 10 | 13 | Female |
| 11 | 22 | Female |
| 12 | 32 | Male |
| 13 | 17 | Male |
| 14 | 14 | Female |
| 15 | 13 | Male |
| 16 | 14 | Female |

Step 202. Filter the target users in the target user set according to a type of a to-be-obtained social relationship chain, a gender and an age of the center user, and genders and ages of the target users in the target user set.

In this exemplary embodiment, the parent-child relationship chain may be classified into eight social relationship chain types in a center user-target user form: father-son (the center user is a father, and the social network needs to be searched for a son of the center user), son-father (the center user is a son, and the social network needs to be searched for a father of the center user), father-daughter (the center user is a father, and the social network needs to be searched for a daughter of the center user), daughter-father (the center user is a daughter, and the social network needs to be searched for a father of the center user), mother-son (the center user is a mother, and the social network needs to be searched for a son of the center user), son-mother (the center user is a son, and the social network needs to be searched for a mother of the center user), mother-daughter (the center user is a mother, and the social network needs to be searched for a daughter of the center user), and daughter-mother (the center user is a daughter, and the social network needs to be searched for a mother of the center user). The eight social relationship types all require ages and genders of the center user and the target user to satisfy a particular condition. For example, when the center user and the target user are in a mother-son relationship, it means that the center user must be female, and the target user must be male, and the center user is generally older than the target user and an age difference between the two is within a preset age range. The preset age range is usually greater than or equal to 15 and less than or equal to 45.

In an exemplary embodiment, this step may specifically include the following first and second steps during implementation:

First step: Determine, according to the type of a to-be-obtained social relationship chain and the gender and age of the center user, a gender and an age range of a target user to be retained in the target user set.

The type of a to-be-obtained social relationship chain may be set by technical personnel.

In the first step, when the gender of the center user is male, four type of a to-be-obtained social relationship chains are set for the center user, including: father-son, father-daughter, son-father, and son-mother. In the first step, for each of the four social relationship chain types, a detailed implementation process is as follows:

When the type of a to-be-obtained social relationship chain is father-son, that is, the center user is a father and the social network needs to be searched for his son, female target users need to be removed and male targets are retained. Therefore, it may be determined in the first step that the gender of the target user to be retained in the target user set is male, and the target user should be younger than the center user and an age difference between the two should be within the preset age range. Therefore, the age range of the target user to be retained in the target user set may be determined according to the age of the center user and the preset age range. For example, it is assumed that the age of the center user is 50, and the preset age range is greater than or equal to 15 and less than or equal to 45. Therefore, it may be determined in the first step that the age range of the target user to be retained in the target user set is greater than or equal to 5 and less than or equal to 35.

When the type of a to-be-obtained social relationship chain is father-daughter, that is, the center user is a father and the social network needs to be searched for his daughter, male target users need to be removed and female targets are retained. Therefore, it may be determined in the first step that the gender of the target user to be retained in the target user set is female, and the target user should be younger than the center user and an age difference between the two should be within the preset age range. Therefore, the age range of the target user to be retained in the target user set may be determined according to the age of the center user and the preset age range.

When the type of a to-be-obtained social relationship chain is son-father, that is, the center user is a son and the social network needs to be searched for his father, female target users need to be removed and male targets are retained. Therefore, it may be determined in the first step that the gender of the target user needing to be removed is female, and the target user should be older than the center user and an age difference between the two should be within the preset age range. Therefore, the age range of the target user to be retained in the target user set may be determined in the first step according to the age of the center user and the preset age range. For example, it is assumed that the age of the center user is 15, and the preset age range is greater than or equal to 15 and less than or equal to 45. Therefore, it may be determined in the first step that the age range of the target user to be retained in the target user set is greater than or equal to 30 and less than or equal to 60.

When the type of a to-be-obtained social relationship chain is son-mother, that is, the center user is a son and the social network needs to be searched for his mother, male target users need to be removed and female targets are retained. Therefore, it may be determined in the first step that the gender of the target user to be retained in the target user set is female, and the target user should be older than the center user and an age difference between the two should be within the preset age range. Therefore, the age range of the target user to be retained in the target user set may be determined according to the age of the center user and the preset age range.

In the first step, when the gender of the center user is female, four type of a to-be-obtained social relationship chains are set for the center user, including: mother-son, mother-daughter, daughter-father, and daughter-mother. In the first step, for each of the four social relationship chain types, a detailed implementation process is as follows:

When the type of a to-be-obtained social relationship chain is mother-son, that is, the center user is a mother and the social network needs to be searched for her son, female target users need to be removed and male targets are retained. Therefore, it may be determined in the first step that the gender of the target user to be retained in the target user set is male, and the target user should be younger than the center user and an age difference between the two should be within the preset age range. Therefore, the age range of the target user to be retained in the target user set may be determined according to the age of the center user and the preset age range.

When the type of a to-be-obtained social relationship chain is mother-daughter, that is, the center user is a mother and the social network needs to be searched for her daughter, male target users need to be removed and female targets are retained. Therefore, it may be determined in the first step that the gender of the target user to be retained in the target user set is female, and the target user should be younger than the center user and an age difference between the two should be within the preset age range. Therefore, the age range of the target user to be retained in the target user set may be determined according to the age of the center user and the preset age range.

When the type of a to-be-obtained social relationship chain is daughter-father, that is, the center user is a daughter and the social network needs to be searched for her father, female target users need to be removed and male targets are retained. Therefore, it may be determined in the first step that the gender of the target user needing to be removed is female, and the target user should be older than the center user and an age difference between the two should be within the preset age range. Therefore, the age range of the target user to be retained in the target user set may be determined according to the age of the center user and the preset age range in the first step.

When the type of a to-be-obtained social relationship chain is daughter-mother, that is, the center user is a daughter and the social network needs to be searched for her mother, male target users need to be removed and female targets are retained. Therefore, it may be determined in the first step that the gender of the target user to be retained in the target user set is female, and the target user should be older than the center user and an age difference between the two should be within the preset age range. Therefore, the age range of the target user to be retained in the target user set may be determined according to the age of the center user and the preset age range.

For example, for the center user C, the age of the center user C is 40 and the gender is female, and it is assumed that the preset age range is greater than or equal to 15 and less than or equal to 45, and the type of a to-be-obtained social relationship chain is mother-son. Therefore, it may be determined that the gender to be retained in the target user set is male, and according to the age 40 of the center user C and the preset age range, the age range of the target user to be retained in the target user set is greater than or equal to 0 and less than or equal to 25.

Second step: Remove, from the target user set, a target user whose gender is different from the determined gender and a target user whose age is not within the determined age range.

For example, it is determined in the first step that the gender to be retained in the target user set is male, and the age range of the target user to be retained in the target user set is greater than or equal to 0 and less than or equal to 25. Therefore, in the second step, target users 1, 5, 6, 10, 11, 14, and 16 whose genders are female and target users 4, 7, and 9 whose ages are less than 0 or greater than 25 are removed from the target user set shown in Table 1, and retained target users include 2, 3, 8, 13, and 15, as shown in Table 2.

TABLE 2

| Target user | Age | Gender |
|---|---|---|
| 2 | 16 | Male |
| 3 | 15 | Male |
| 8 | 14 | Male |
| 13 | 17 | Male |
| 15 | 13 | Male |

The target users are filtered according to the age and gender, so that a range of the target user set may be reduced, which reduces a subsequent algorithm calculation amount, and helps improve accuracy of a final result. For example, assuming that a mother-son relationship chain of the center user is to be obtained, when filtering is not performed based on the ages and genders of the center user and the target users, each friend of the center user may be her son. However, when filtering is performed based on the ages and genders, a candidate range of the son of the center user is greatly reduced, which may reduce a subsequent algorithm calculation amount, and help improve accuracy of a final result.

In addition, it should be noted that, step 202 is an optional step and may be not performed, and the following step 203 is directly performed after step 201 is performed.

Step 203. Construct a social relationship network according to the center user and the mutual-friend information between the any two target users in the target user set. Nodes in the social relationship network are the target users in the target user set, and there is a connection line between two target users in the social relationship network that are in a friend relationship.

The two users in a friend relationship include two target users in a friend relationship, and the center user and a target user that are in a friend relationship.

Optionally, the social relationship network is constructed in this exemplary step by using the following process:

First, a social relationship network centering on the center user is constructed according to the center user and the mutual-friend information between the any two target users in the target user set. In the social relationship network, there is a connection line between the center user and each target user in the target user set, and there is a connection line between any two target users in a friend relationship.

The center user and each target user in the target user set are considered as nodes in the social relationship network, and a line is added between the center user and the target user to connect the center user and the target user. For any two target users in the target user set, when mutual-friend information between the two target users is used to indicate that the two target users are in a friend relationship, a line is added between the two target users to connect the two target users. In this way, the social relationship network of the center user is obtained.

For example, referring to FIG. 2-2, for the center user C and the target user set shown in Table 1, the center user C and the target users 1, 2, 3, 4, . . . , and 16 in the target user set are considered as nodes in the social relationship network, and a line is added between the center user C and each of the target users 1, 2, 3, 4, . . . , and 16. For any two target users in the target user set, using the target users 1 and 2 as an example for description, assuming that mutual-friend information between the target users 1 and 2 is used to indicate that the target users 1 and 2 are in a friend relationship, a line is added between the target users 1 and 2. In this way, the social relationship network of the center user C shown in FIG. 2-2 is obtained.

Step 204. Delete the center user and lines connected to the center user from the social relationship network to obtain a reference network.

For example, the center user C and lines connected to the center user C are deleted from the social relationship network shown in FIG. 2-2, to obtain a reference network shown in FIG. 2-3.

Step 205. Calculate damage values of the target users in the reference network according to the reference network. A damage value of a target user is used to indicate a degree of damage to connectivity in the reference network when the target user is deleted from the reference network.

For example, a quantity of target users in the reference network that are directly connected to a candidate user is counted to obtain a direct damage value. The candidate user is any user in the reference network. A target user pair satisfying a preset condition is obtained from the target users included in the reference network. A quantity of obtained target user pairs is counted to obtain an indirect damage value, and a damage value of the candidate user is calculated according to the direct damage value and the indirect damage value. The process may be specifically implemented in the following three manners:

A first manner includes: counting a quantity of target users in the reference network that are directly connected to a candidate user to obtain a direct damage value, the candidate user being any user in the reference network; obtaining a first subnetwork from the reference network, the first subnetwork including a mutual friend between the candidate user and the center user; forming a target user pair between any two target users in the first subnetwork to form a user pair set; selecting a target user pair from the user pair set, two target users included in the selected target user pair being unconnected in the first subnetwork or a shortest path between them in the first subnetwork being greater than 2; and counting a quantity of selected target user pairs to obtain an indirect damage value, and calculating a damage value of the candidate user according to the direct damage value and the indirect damage value.

For example, after the reference network shown in FIG. 2-3 is obtained, importance of a candidate user is quantized based on a degree of damage to network connectivity when the candidate user is deleted. After the candidate user in the reference network is deleted, damage to network connectivity generally includes two aspects, and is described by using the target user 3 as an example. In one aspect, the deleted candidate user 3 is no longer connected to the remaining target users, which is a direct loss caused by deletion of the candidate user, represented by a direct damage value L3a. A specific value of L3a is a degree value of the candidate user 3 before the candidate user is deleted, that is, a quantity of mutual neighbors between the candidate user 3 and the center user C. It can be learned from FIG. 2-404 that, the candidate user 3 has four connection lines, that is, a degree of the candidate user 3 is 4, and therefore, L3a=4.

In the other aspect, after the candidate user 3 is deleted, due to lack of a bridge originally provided by the deleted candidate user, some of the remaining target users may be no longer connected or a shortest path between the target users becomes longer. Such a loss is referred to as an indirect loss, represented by an indirect damage value L3b.

FIG. 2-401 shows a first subnetwork formed by mutual friends between the candidate user 3 and the center user C. As shown in the figure, when the candidate user 3 exists, the candidate user 3 is connected to the other target users in the first subnetwork, and a shortest path between any two target users in the first subnetwork is less than or equal to 2. When the candidate user 3 is deleted, that is, the dotted-line candidate user 3 and connection lines in FIG. 2-402 are all removed, when impact caused by deletion of the candidate user 3 is considered only in the first subnetwork formed by mutual neighbors between the candidate user 3 and the center user C, as shown in FIG. 2-403, and a distance between any two target users in the first subnetwork is greater than 2 or the two are no longer connected, it indicates that a distance between two target users becomes longer after the candidate user 3 is deleted.

For example, a mutual neighbor set between the candidate user 3 and the center user C is {1, 2, 4, 16}, and indirect impact caused by deletion of the candidate user 3 is obtained by calculating a shortest path between two target users in the user set {1, 2, 4, 16}. Because the candidate user 3 may function as a bridge between other target users before deleted, a distance between each two target users in the user set {1, 2, 4, 16} is not greater than 2 before the candidate user 3 is deleted. After the candidate user 3 is deleted, when a shortest path between two target users is greater than 2 or the two are unconnected, it indicates that the candidate user 3 functions as a bridge in the first subnetwork, and a value of L3b is increased by 1. It can be learned from information about a shortest path between a node pair shown in Table 3 that, the value of L3b is 5.

TABLE 3

| Number of target user pair | Length of shortest path |
|---|---|
| 1-2 | 1 |
| 1-4 | Unconnected |
| 1-16 | Unconnected |
| 2-4 | Unconnected |
| 2-16 | Unconnected |
| 4-16 | Unconnected |

A second manner includes: counting a quantity of target users in the reference network that are directly connected to a candidate user to obtain a direct damage value, the candidate user being any user in the reference network; deleting the candidate user and a line directly connected to the candidate user from the reference network to obtain a second subnetwork; forming a target user pair between any two target users directly connected to the candidate user to form a user pair set; selecting a target user pair from the user pair set, two target users included in the selected target user pair being unconnected in the second subnetwork or a shortest path between them in the second subnetwork being greater than a shortest path between them in the reference network; and counting a quantity of selected target user pairs to obtain an indirect damage value, and calculating a damage value of the candidate user according to the direct damage value and the indirect damage value.

Referring to FIG. 2-5, when the impact caused by deletion of the candidate user 3 is considered not only in the first subnetwork formed by the mutual neighbors between the deleted candidate user 3 and the center user C, during calculation of a shortest path between nodes when only the nodes are considered, not only connections in the first subnetwork may be used, but also another connection of another node may be used. In this case, when a distance between any two target users in the subnetwork is greater than 2 or the two are no longer connected, it indicates that a distance between two target users becomes longer after the candidate user 3 is deleted. Although the indirect impact is calculated only in the subnetwork formed by the mutual neighbors between the candidate user 3 and the center user C, an external line connected to the subnetwork is also considered, that is, the entire second subnetwork is considered.

For example, as shown in FIG. 2-5, impact on the mutual neighbors between the candidate user 3 and the center user C is still considered after the candidate user 3 is deleted, and a subnetwork formed by the neighbors and the candidate user 3 is shown in a curve range at the upper left corner of FIG. 2-501. After the candidate user 3 is deleted, the second subnetwork is specifically shown in a curve range at the upper left corner of FIG. 2-502. Target user pairs during calculation of a shortest path are still the mutual neighbor set {1, 2, 4, 16} between the deleted candidate user 3 and the center node C, but a bridge provided by another target user outside the set needs to be considered. That is, a shortest path between nodes needs to be calculated in the entire second subnetwork. For example, for a target user pair 1-4, when their connection relationship is considered only in the first subnetwork in the curve range, the two target users are unconnected, and the value of the indirect loss L3b needs to be increased by 1. However, when in the entire second subnetwork, because the target user 5 is a mutual neighbor between the target users 1 and 4, and functions as a bridge, a shortest path between the target user pair 1-4 is 2, and does not increase the indirect loss L3b. Therefore, in a semi-local method, information about a shortest path between a target user pair is shown in Table 4, and the value of L3b is 4.

TABLE 4

| Number of target user pair | Length of shortest path |
|---|---|
| 1-2 | 1 |
| 1-4 | 2 |
| 1-16 | Unconnected |
| 2-4 | Unconnected |
| 2-16 | Unconnected |
| 4-16 | Unconnected |

A third manner includes: counting a quantity of target users in the reference network that are directly connected to a candidate user to obtain a direct damage value, the candidate user being any user in the reference network; deleting the candidate user and a line directly connected to the candidate user from the reference network to obtain a second subnetwork; forming a target user pair between any two target users in the second subnetwork to form a user pair set; selecting a target user pair from the user pair set, two target users included in the selected target user pair being unconnected in the second subnetwork or a shortest path between them in the second subnetwork being greater than a shortest path between them in the reference network; and counting a quantity of selected target user pairs to obtain an indirect damage value, and calculating a damage value of the candidate user according to the direct damage value and the indirect damage value.

Referring to FIG. 2-6, the impact caused by deletion of the candidate user 3 is not considered only in the first subnetwork formed by the mutual neighbors between the candidate user 3 and the center user C, but considered in the entire reference network. That is, after the candidate user 3 is deleted, when a distance between any two target users in the reference network becomes longer than that before the candidate user 3 is deleted, it indicates that a distance between two target users becomes longer after the candidate user 3 is deleted, which is considered as impact of the candidate user 3 on the entire reference network. The indirect impact is calculated in the entire reference network of the center user C, and therefore is a global indicator.

For example, a connection network of the deleted candidate user 3 is first found, as shown in FIG. 2-601, and a shortest path between any two target users in a set of other users {1, 2, 4, 5, 13, 14, 15, 16} obtained after the candidate user 3 is deleted is calculated. Then, after the candidate user 3 is deleted, as shown in FIG. 2-602, the shortest path between the any two target users in the user set {1, 2, 4, 5, 13, 14, 15, 16} is calculated again. For any target user pair, when results calculated before and after the candidate user 3 is deleted are the same, it indicates that whether the candidate user 3 is deleted does not affect the target user pair, and does not increase the indirect loss L3b. When calculated lengths of a shortest path between a target user pair are different, for example, the shortest path becomes longer after the candidate user 3 is deleted, it indicates that the candidate user 3 functions as a bridge in their relationship, and therefore, the value of the indirect loss L3b needs to be increased by 1. Table 5 lists shortest paths between all target user pairs, there are 17 target user pairs whose shortest paths change, and therefore, the value of L3b is 17.

TABLE 5

| | Shortest path | Shortest path |
|---|---|---|
| | between target user | between target user |
| Number of | pair before candidate | pair after candidate |
| target user pair | user 3 is deleted | user 3 is deleted |
| 1-2 | 1 | 1 |
| 1-4 | 2 | 2 |
| 1-5 | 1 | 1 |
| 1-13 | 3 | Unconnected |
| 1-14 | 4 | Unconnected |
| 1-15 | 4 | Unconnected |
| 1-16 | 2 | Unconnected |
| 2-4 | 2 | 3 |
| 2-5 | 2 | 2 |
| 2-13 | 3 | Unconnected |
| 2-14 | 4 | Unconnected |
| 2-15 | 4 | Unconnected |
| 2-16 | 2 | Unconnected |
| 4-5 | 1 | 1 |
| 4-13 | 3 | Unconnected |
| 4-14 | 4 | Unconnected |
| 4-15 | 4 | Unconnected |
| 4-16 | 2 | Unconnected |
| 5-13 | 4 | Unconnected |
| 5-14 | 5 | Unconnected |
| 5-15 | 5 | Unconnected |
| 5-16 | 3 | Unconnected |
| 13-14 | 1 | 1 |
| 13-15 | 1 | 1 |
| 13-16 | 1 | 1 |
| 14-15 | 1 | 1 |
| 14-16 | 2 | 2 |
| 15-16 | 2 | 2 |

For the direct damage value L3a and the indirect damage value L3b obtained in the foregoing three manners, a damage value of each candidate user is a weighted sum of a direct damage value and an indirect damage value. For the candidate user 3, whose damage value is represented by L3Z, L3Z=αL3a+(1−α)L3b, which indicates a total degree of damage to connectivity in the entire network when the candidate user 3 is deleted, and is an importance indicator of the deleted candidate user 3. α and 1−α are weighting coefficients and 0≤α≤1, and they respectively represent relative weights of a direct loss and an indirect loss to the entire network when a candidate user is deleted. The weights may be selected according to specific situations of different social networks, to achieve an optimum detection effect. In this exemplary embodiment, it may be set that α=0.5 and L3Z=(L3a+L3b)/2.

Step 206. Determine a target user having a maximum damage value as a target user who is in a parent-child relationship chain with the center user.

Parent and child nodes are identified by sorting damage values obtained after candidate users are deleted. For each candidate user, a damage value L_{Z} of the candidate user in network connectivity may be calculated. In this case, all candidate users are sorted according to damage values, and the target user having the maximum damage value is a parent or child user needing to be found. For example, Table 6 lists damage values obtained based on a local indicator, a semi-local indicator, and a global indicator after candidate users are deleted. Because L_{Z} of the target user 3 is maximum, there is a mother-son relationship chain between the center user C and the target user 3, the center user C is the mother of the target user 3, and the target user 3 is the son of the center user C.

TABLE 6

| | | | L_{Z} based |
|---|---|---|---|
| User | L_{Z} based on local | L_{Z} based on semi-local | on global indicator |
| number | indicator | indicator | (female) |
| 2 | 1.00 | 1.00 | 1.00 |
| 3 | 4.50 | 4.00 | 10.50 |
| 8 | 2.00 | 2.00 | 2.00 |
| 13 | 2.50 | 2.50 | 7.50 |
| 15 | 1.00 | 1.00 | 1.00 |

The method and system proposed by the present disclosure have the following advantages. In one aspect, target users are filtered by using age, gender, and other attribute information of the target users, which greatly reduces a range of a candidate user set, reduces an entire algorithm calculation amount, and lays a good foundation for increasing an identification recall rate. In addition, the present disclosure quantizes importance of a candidate user based on a degree of damage to network connectivity when the candidate user is deleted, and because direct impact (similar to a degree centrality indicator) and indirect impact (similar to a dispersion indicator) of the candidate user are fully considered, better identification accuracy is achieved than common social network centrality indicators.

Referring to FIG. 3, an embodiment of the present disclosure provides a social relationship chain obtaining apparatus, including:
an obtaining device 301, configured to obtain a target user set and mutual-friend information between any two target users in the target user set, target users in the target user set being friends of a center user, and the mutual-friend information being used to indicate whether the two target users are in a friend relationship;
a construction device 302, configured to construct a reference network according to the center user and the mutual-friend information between the any two target users in the target user set, nodes in the reference network being the target users in the target user set, and there being a connection line between two target users in the reference network that are in a friend relationship; and
a determining device 303, configured to determine, from the target user set according to the reference network, a target user who is in a parent-child relationship chain with the center user.

Optionally, the apparatus further includes:
a filtering module, configured to filter the target users in the target user set according to a type of a to-be-obtained social relationship chain, a gender and an age of the center user, and genders and ages of the target users in the target user set.

Optionally, the filtering module includes:
a determining unit, configured to determine, according to the type of a to-be-obtained social relationship chain and the gender and age of the center user, a gender and an age range of a target user to be retained in the target user set; and
a filtering unit, configured to remove, from the target user set according to the determined gender and age range, a target user whose gender is different from the determined gender and a target user whose age is not within the age range.

Optionally, the determining unit includes:
a calculation unit, configured to calculate damage values of the target users in the reference network according to the reference network, a damage value of a target user being used to indicate a degree of damage to connectivity in the reference network when the target user is deleted from the reference network; and
a determining unit, configured to determine a target user having a maximum damage value as the target user who is in a parent-child relationship chain with the center user.

Optionally, the calculate unit is configured to count a quantity of target users in the reference network that are directly connected to a candidate user to obtain a direct damage value, the candidate user being any user in the reference network; and obtain a first subnetwork from the reference network, the first subnetwork including a mutual friend between the candidate user and the center user;
form a target user pair between any two target users in the first subnetwork to form a user pair set;
select a target user pair from the user pair set, two target users included in the selected target user pair being unconnected in the first subnetwork or a shortest path between them in the first subnetwork being greater than 2; and
count a quantity of selected target user pairs to obtain an indirect damage value, and calculate a damage value of the candidate user according to the direct damage value and the indirect damage value.

Optionally, the calculate unit is configured to count a quantity of target users in the reference network that are directly connected to a candidate user to obtain a direct damage value, the candidate user being any user in the reference network;
delete the candidate user and a line directly connected to the candidate user from the reference network to obtain a second subnetwork;
form a target user pair between any two target users directly connected to the candidate user to form a user pair set;
select a target user pair from the user pair set, two target users included in the selected target user pair being unconnected in the second subnetwork or a shortest path between them in the second subnetwork being greater than a shortest path between them in the reference network; and
count a quantity of selected target user pairs to obtain an indirect damage value, and calculate a damage value of the candidate user according to the direct damage value and the indirect damage value.

Optionally, the calculate unit is configured to count a quantity of target users in the reference network that are directly connected to a candidate user to obtain a direct damage value, the candidate user being any user in the reference network;
delete the candidate user and a line directly connected to the candidate user from the reference network to obtain a second subnetwork;
form a target user pair between any two target users in the second subnetwork to form a user pair set;
select a target user pair from the user pair set, two target users included in the selected target user pair being unconnected in the second subnetwork or a shortest path between them in the second subnetwork being greater than a shortest path between them in the reference network; and
count a quantity of selected target user pairs to obtain an indirect damage value, and calculate a damage value of the candidate user according to the direct damage value and the indirect damage value.

In this exemplary embodiment of the present disclosure, a target user set and mutual-friend information between any two target users in the target user set are obtained; a reference network is constructed according to the center user and the mutual-friend information between the any two target users in the target user set; and a target user, being in a parent-child relationship chain with the center user, is determined from the target user set according to the reference network. As such, even if a user does not mark parent or child information in a contact list, the parent-child relationship chain of the center user can still be identified.

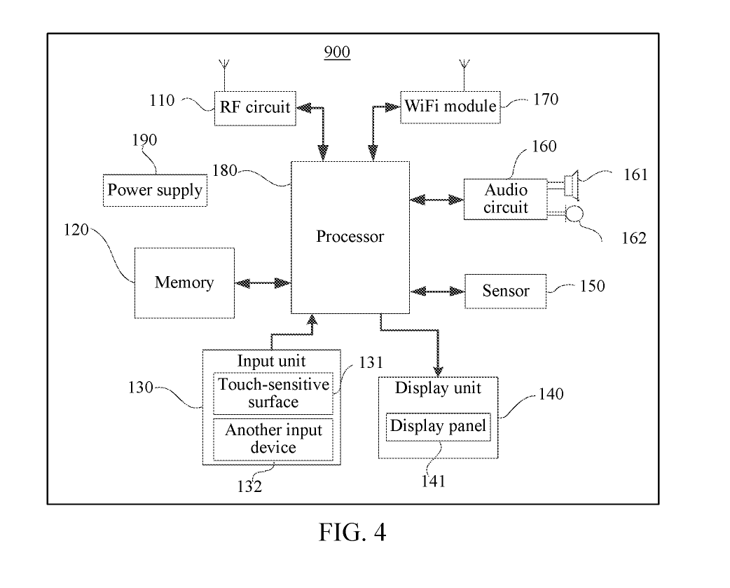

Referring to FIG. 4, FIG. 4 is a schematic structural diagram of a terminal. The terminal is configured to implement a social relationship chain obtaining method provided in the foregoing embodiment. Specifically:

The terminal 900 may include components such as a radio frequency (RF) 110, a memory 120 including one or more computer readable storage media, an input unit 130, a display unit 140, a sensor 150, an audio circuit 160, a wireless fidelity (WiFi) module 170, a processor 180 including one or more processing cores, and a power supply 190. A person skilled in the art may understand that the structure of the terminal shown in FIG. 4 does not constitute a limitation to the terminal, and the terminal may include more or fewer components than those shown in the figure, or some components may be combined, or a different component deployment may be used.

The RF circuit 110 may be configured to receive and send signals during an information receiving and sending process or a call process. Particularly, the RF circuit 110 receives downlink information from a base station, then delivers the downlink information to the processor 180 for processing, and sends related uplink data to the base station. Usually, the RF circuit 110 includes, but is not limited to, an antenna, at least one amplifier, a tuner, one or more oscillators, a subscriber identity module (SIM) card, a transceiver, a coupler, a low noise amplifier (LNA), and a duplexer. In addition, the RF circuit 110 may also communicate with a network and another device by means of wireless communication. The wireless communication may use any communication standard or protocol, including but not limited to Global System for Mobile communications (GSM), general packet radio service (GPRS), Code Division Multiple Access (CDMA), Wideband Code Division Multiple Access (WCDMA), Long Term Evolution (LTE), email, Short Messaging Service (SMS), and the like.

The memory 120 may be configured to store a software program and module. The processor 180 runs the software program and module stored in the memory 120, to implement various functional applications and data processing. The memory 120 may mainly include a program storage area and a data storage area. The program storage area may store an operating system, an application program required by at least one function (such as a sound playback function and an image display function). The data storage area may store data (such as audio data and an address book) created according to use of the terminal 900. In addition, the memory 120 may include a high speed random access memory, and may also include a non-volatile memory, such as at least one magnetic disk storage device, a flash memory, or another volatile solid-state storage device. Correspondingly, the memory 120 may further include a memory controller, so as to provide access of the processor 180 and the input unit 130 to the memory 120.

The input unit 130 may be configured to receive input digit or character information, and generate a keyboard, mouse, joystick, optical, or track ball signal input related to the user setting and function control. For example, the input unit 130 may include a touch-sensitive surface 131 and another input device 132. The touch-sensitive surface 131, which may also be referred to as a touchscreen or a touch panel, may collect a touch operation of a user on or near the touch-sensitive surface (such as an operation of a user on or near the touch-sensitive surface 131 by using any suitable object or accessory, such as a finger or a stylus), and drive a corresponding connection apparatus according to a preset program. Optionally, the touch-sensitive surface 131 may include two parts: a touch detection apparatus and a touch controller. The touch detection apparatus detects a touch direction of the user, detects a signal generated by the touch operation, and transfers the signal to the touch controller. The touch controller receives touch information from the touch detection apparatus, converts the touch information into touch point coordinates, and then sends the touch point coordinates to the processor 180. Moreover, the touch controller can receive and execute a command sent from the processor 180. In addition, the touch-sensitive surface 131 may be may be a resistive, capacitive, infrared, or surface sound wave type touch-sensitive surface. In addition to the touch-sensitive surface 131, the input unit 130 may further include the another input device 132. For example, the another input device 132 may include, but is not limited to, one or more of a physical keyboard, a functional key (such as a volume control key or a switch key), a track ball, a mouse, and a joystick.

The display unit 140 may be configured to display information input by the user or information provided for the user, and various graphical user ports of the terminal 900. The graphical user ports may be formed by a graph, a text, an icon, a video, and any combination thereof. The display unit 140 may include a display panel 141. Optionally, the display panel 141 may be configured by using a liquid crystal display (LCD), an organic light-emitting diode (OLED), or the like. Further, the touch-sensitive surface 131 may cover the display panel 141. After detecting a touch operation on or near the touch-sensitive surface 131, the touch-sensitive surface 131 transfers the touch operation to the processor 180, so as to determine the type of the touch event. Then, the processor 180 provides a corresponding visual output on the display panel 141 according to the type of the touch event. Although in FIG. 4, the touch-sensitive surface 131 and the display panel 141 are used as two separate parts to implement input and output functions, in some embodiments, the touch-sensitive surface 131 and the display panel 141 may be integrated to implement the input and output functions.

The terminal 900 may further include at least one sensor 150, such as an optical sensor, a motion sensor, and other sensors. For example, the optical sensor may include an ambient light sensor and a proximity sensor. The ambient light sensor may adjust luminance of the display panel 141 according to brightness of the ambient light. The proximity sensor may switch off the display panel 141 and/or backlight when the terminal 900 is moved to the ear. As one type of motion sensor, a gravity acceleration sensor may detect magnitude of accelerations at various directions (which generally are triaxial), may detect magnitude and a direction of the gravity when static, and may be configured to identify an application of a mobile phone gesture (such as switchover between horizontal and vertical screens, a related game, and gesture calibration of a magnetometer), a related function of vibration identification (such as a pedometer and a knock). Other sensor, such as a gyroscope, a barometer, a hygrometer, a thermometer, and an Infrared sensor, which may be configured in the terminal 900 are not further described herein.

The audio circuit 160, a speaker 161, and a microphone 162 may provide audio interfaces between the user and the terminal 900. The audio circuit 160 may transmit, to the speaker 161, a received electric signal converted from received audio data. The speaker 161 converts the electric signal into a sound signal for output. On the other hand, the microphone 162 converts a collected sound signal into an electric signal. The audio circuit 160 receives the electric signal and converts the electric signal into audio data, and outputs the audio data to the processor 180 for processing. Then, the processor 180 sends the audio data to, for example, another terminal, by using the RF circuit 110, or outputs the audio data to the memory 120 for further processing. The audio circuit 160 may further include an earplug jack, so as to provide communication between a peripheral earphone and the terminal 900.

WiFi belongs to a short distance wireless transmission technology. The terminal 900 may help, by using the WiFi unit 170, a user to receive and send an email, browse a web page, and access stream media, and the like, which provides wireless broadband Internet access for the user. Although FIG. 4 shows the WiFi module 170, it may be understood that, the WiFi module does not belong to a necessary constitution of the terminal 900, and can be ignored according to demands without changing the scope of the essence of the present disclosure.

The processor 180 is a control center of the terminal 900, and connects to various parts of the mobile phone by using various interfaces and lines. By running or executing the software program and/or module stored in the memory 120, and invoking data stored in the memory 120, the processor 180 performs various functions and data processing of the terminal 900, thereby performing overall monitoring on the mobile phone. Optionally, the processor 180 may include one or more processor cores. Preferably, the processor 180 may integrate an application processor and a modem. The application processor mainly processes an operating system, a user interface, an application program, and the like. The modem mainly processes wireless communication. It may be understood that the foregoing modem processor may not be integrated into the processor 180.

The terminal 900 further includes the power supply 190 (such as a battery) for supplying power to the components. Preferably, the power supply may logically connect to the processor 180 by using a power supply management system, thereby implementing functions, such as charging, discharging, and power consumption management, by using the power supply management system. The power supply 190 may further include one or more of a direct current or alternating current power supply, a re-charging system, a power failure detection circuit, a power supply converter or inverter, a power supply state indicator, and any other components.

Although not shown in the figure, the terminal 900 may further include a camera, a Bluetooth module, and the like, which are not further described herein. For example, in this exemplary embodiment, the display unit of the terminal 900 is a touchscreen display, and the terminal 900 further includes a memory and one or more programs. The one or more programs are stored in the memory and executed by one or more processors. The one or more programs include an instruction used to perform the following operations:
obtaining a target user set and mutual-friend information between any two target users in the target user set, target users in the target user set being friends of a center user, and the mutual-friend information being used to indicate whether the two target users are in a friend relationship;
constructing a reference network according to the center user and the mutual-friend information between the any two target users in the target user set, nodes in the reference network being the target users in the target user set, and there being a connection line between two target users in the reference network that are in a friend relationship; and
determining, from the target user set according to the reference network, a target user who is in a parent-child relationship chain with the center user.

Optionally, before the constructing a reference network according to the center user and the mutual-friend information between the any two target users in the target user set, the following operation is further included:
filtering the target users in the target user set according to a type of a to-be-obtained social relationship chain, a gender and an age of the center user, and genders and ages of the target users in the target user set.

Optionally, the filtering the target users in the target user set according to a type of a to-be-obtained social relationship chain, a gender and an age of the center user, and genders and ages of the target users in the target user set includes:
determining, according to the type of a to-be-obtained social relationship chain and the gender and age of the center user, a gender and an age range of a target user to be retained in the target user set; and
removing, from the target user set according to the determined gender and age range, a target user whose gender is different from the determined gender and a target user whose age is not within the age range.

Optionally, the determining, from the target user set according to the reference network, a target user who is in a parent-child relationship chain with the center user includes:
calculating damage values of the target users in the reference network according to the reference network, a damage value of a target user being used to indicate a degree of damage to connectivity in the reference network when the target user is deleted from the reference network; and
determining a target user having a maximum damage value as the target user who is in a parent-child relationship chain with the center user.

Optionally, the calculating damage values of the target users in the reference network according to the reference network includes:
counting a quantity of target users in the reference network that are directly connected to a candidate user to obtain a direct damage value, the candidate user being any user in the reference network; and obtaining a first subnetwork from the reference network, the first subnetwork including a mutual friend between the candidate user and the center user;
forming a target user pair between any two target users in the first subnetwork to form a user pair set;
selecting a target user pair from the user pair set, two target users included in the selected target user pair being unconnected in the first subnetwork or a shortest path between them in the first subnetwork being greater than 2; and
counting a quantity of selected target user pairs to obtain an indirect damage value, and calculating a damage value of the candidate user according to the direct damage value and the indirect damage value.

Optionally, the calculating damage values of the target users in the reference network according to the reference network includes:
counting a quantity of target users in the reference network that are directly connected to a candidate user to obtain a direct damage value, the candidate user being any user in the reference network;
deleting the candidate user and a line directly connected to the candidate user from the reference network to obtain a second subnetwork;
forming a target user pair between any two target users directly connected to the candidate user to form a user pair set;
selecting a target user pair from the user pair set, two target users included in the selected target user pair being unconnected in the second subnetwork or a shortest path between them in the second subnetwork being greater than a shortest path between them in the reference network; and
counting a quantity of selected target user pairs to obtain an indirect damage value, and calculating a damage value of the candidate user according to the direct damage value and the indirect damage value.

Optionally, the calculating damage values of the target users in the reference network according to the reference network includes:
counting a quantity of target users in the reference network that are directly connected to a candidate user to obtain a direct damage value, the candidate user being any user in the reference network;
deleting the candidate user and a line directly connected to the candidate user from the reference network to obtain a second subnetwork;
forming a target user pair between any two target users in the second subnetwork to form a user pair set;
selecting a target user pair from the user pair set, two target users included in the selected target user pair being unconnected in the second subnetwork or a shortest path between them in the second subnetwork being greater than a shortest path between them in the reference network; and
counting a quantity of selected target user pairs to obtain an indirect damage value, and calculating a damage value of the candidate user according to the direct damage value and the indirect damage value.

In an exemplary embodiment, a non-transitory computer readable storage medium including an instruction, for example, a memory including an instruction, is further provided. The instruction may be executed by a processor of a terminal to implement the foregoing social relationship chain obtaining method. For example, the non-transitory computer readable storage medium may be a ROM, a random access memory (RAM), a CD-ROM, a magnetic tape, a floppy disk, or an optical data storage device.

A person of ordinary skill in the art may understand that all or some of the steps of the foregoing embodiments may be implemented by using hardware, or may be implemented by a program instructing relevant hardware. The program may be stored in a computer readable storage medium. The storage medium may be a read-only memory, a magnetic disk, an optical disc, or the like.

The foregoing descriptions are merely preferred embodiments of the present disclosure, but are not intended to limit the present disclosure. Any modification, equivalent replacement, or improvement made within the spirit and principle of the present disclosure shall fall within the protection scope of the present disclosure.

What is claimed is:

1. A social relationship chain obtaining method, applied to a terminal including at least a memory and a processor, the method comprising:
obtaining a target user set and mutual-friend information between any two target users in the target user set, target users in the target user set being friends of a center user, and the mutual-friend information indicating whether the two target users are in a friend relationship;
constructing a reference network according to the center user and the mutual-friend information between the any two target users in the target user set, nodes in the reference network being the target users in the target user set, and there being a connection line between two target users in the reference network that are in a friend relationship; and
determining, from the target user set according to the reference network, a target user being in a parent-child relationship chain with the center user.

2. The method according to claim 1, before constructing the reference network, further comprising:
filtering the target users in the target user set according to a type of a to-be-obtained social relationship chain, a gender and an age of the center user, and genders and ages of the target users in the target user set.

3. The method according to claim 2, wherein filtering the target users in the target user set comprises:
determining, according to the type of the to-be-obtained social relationship chain and the gender and age of the center user, a gender and an age range of a target user to be retained in the target user set; and
removing, from the target user set according to the determined gender and age range, a target user whose gender is different from the determined gender and a target user whose age is not within the age range.

4. The method according to claim 1, wherein the determining, from the target user set according to the reference network, a target user being in a parent-child relationship chain with the center user comprises:
calculating damage values of the target users in the reference network, a damage value of a target user indicating a degree of damage to connectivity in the reference network when the target user is removed from the reference network; and
determining a target user having a maximum damage value as the target user being in a parent-child relationship chain with the center user.

5. The method according to claim 4, wherein the calculating damage values of the target users in the reference network comprises:
counting a quantity of target users in the reference network that are directly connected to a candidate user to obtain a direct damage value, the candidate user being any user in the reference network;
obtaining a target user pair satisfying a preset condition from the target users contained in the reference network; and
counting a quantity of obtained target user pairs to obtain an indirect damage value, and calculating a damage value of the candidate user according to the direct damage value and the indirect damage value.

6. The method according to claim 5, wherein the obtaining a target user pair satisfying a preset condition from the target users contained in the reference network comprises:
obtaining a first subnetwork from the reference network, the first subnetwork comprising a mutual friend between the candidate user and the center user;
forming a target user pair between any two target users in the first subnetwork to form a user pair set; and
selecting a target user pair from the user pair set, two target users contained in the selected target user pair being unconnected in the first subnetwork or having a shortest path there-between in the first subnetwork greater than 2.

7. The method according to claim 5, wherein the obtaining a target user pair satisfying a preset condition from the target users contained in the reference network comprises:
deleting the candidate user and a line directly connected to the candidate user from the reference network to obtain a second subnetwork;
forming a target user pair between any two target users who are directly connected to the candidate user to form a user pair set; and
selecting a target user pair from the user pair set, two target users contained in the selected target user pair being unconnected in the second subnetwork or having a shortest path there-between in the second subnetwork greater than a shortest path there-between in the reference network.

8. The method according to claim 5, wherein the obtaining a target user pair satisfying a preset condition from the target users contained in the reference network comprises:
deleting the candidate user and a line directly connected to the candidate user from the reference network to obtain a second subnetwork;
forming a target user pair between any two target users in the second subnetwork to form a user pair set; and
selecting a target user pair from the user pair set, two target users contained in the selected target user pair being unconnected in the second subnetwork or having a shortest path there-between in the second subnetwork greater than a shortest path there-between in the reference network.

9. A social relationship chain obtaining terminal, comprising:
a memory, storing program instructions for a social relationship chain obtaining method; and
one or more processors, coupled to the memory and, when executing the program instructions, configured for:
obtaining a target user set and mutual-friend information between any two target users in the target user set, target users in the target user set being friends of a center user, and the mutual-friend information indicating whether the two target users are in a friend relationship;
constructing a reference network according to the center user and the mutual-friend information between the any two target users in the target user set, nodes in the reference network being the target users in the target user set, and there being a connection line between two target users in the reference network that are in a friend relationship; and
determining, from the target user set according to the reference network, a target user being in a parent-child relationship chain with the center user.

10. The terminal according to claim 9, wherein the one or more processors are further configured for:
filtering the target users in the target user set according to a type of a to-be-obtained social relationship chain, a gender and an age of the center user, and genders and ages of the target users in the target user set.

11. The terminal according to claim 10, wherein the one or more processors are further configured for:
determining, according to the type of a to-be-obtained social relationship chain and the gender and age of the center user, a gender and an age range of a target user to be retained in the target user set; and
removing, from the target user set according to the determined gender and age range, a target user whose gender is different from the determined gender and a target user whose age is not within the age range.

12. The terminal according to claim 9, wherein the one or more processors are further configured for:
calculating damage values of the target users in the reference network, a damage value of a target user indicating a degree of damage to connectivity in the reference network when the target user is removed from the reference network; and
determining a target user having a maximum damage value as the target user, the target user and the center user being in a parent-child relationship chain.

13. The terminal according to claim 11, wherein the one or more processors are further configured for:
counting a quantity of target users in the reference network that are directly connected to a candidate user to obtain a direct damage value, the candidate user being any user in the reference network;
obtaining a target user pair satisfying a preset condition from the target users contained in the reference network; and
counting a quantity of obtained target user pairs to obtain an indirect damage value, and calculating a damage value of the candidate user according to the direct damage value and the indirect damage value.

14. The terminal according to claim 13, wherein the one or more processors are further configured for:
obtaining a first subnetwork from the reference network, the first subnetwork comprising a mutual friend between the candidate user and the center user;
forming a target user pair between any two target users in the first subnetwork to form a user pair set; and
selecting a target user pair from the user pair set, two target users contained in the selected target user pair being unconnected in the first subnetwork or having a shortest path there-between in the first subnetwork greater than 2.

15. The terminal according to claim 13, wherein the one or more processors are further configured for:
deleting the candidate user and a line directly connected to the candidate user from the reference network to obtain a second subnetwork;
forming a target user pair between any two target users who are directly connected to the candidate user to form a user pair set; and
selecting a target user pair from the user pair set, two target users contained in the selected target user pair being unconnected in the second subnetwork or having a shortest path there-between in the second subnetwork greater than a shortest path there-between in the reference network.

16. The terminal according to claim 13, wherein the one or more processors are further configured for:
deleting the candidate user and a line directly connected to the candidate user from the reference network to obtain a second subnetwork;
forming a target user pair between any two target users in the second subnetwork to form a user pair set; and
selecting a target user pair from the user pair set, two target users contained in the selected target user pair being unconnected in the second subnetwork or having a shortest path there-between in the second subnetwork greater than a shortest path there-between in the reference network.

17. A non-transitory computer-readable storage medium containing computer-executable program instructions for, when executed by a processor, performing a social relationship chain obtaining method, the method comprising:
obtaining a target user set and mutual-friend information between any two target users in the target user set, target users in the target user set being friends of a center user, and the mutual-friend information indicating whether the two target users are in a friend relationship;
constructing a reference network according to the center user and the mutual-friend information between the any two target users in the target user set, nodes in the reference network being the target users in the target user set, and there being a connection line between two target users in the reference network that are in a friend relationship; and
determining, from the target user set according to the reference network, a target user being in a parent-child relationship chain with the center user.

18. The storage medium according to claim 17, wherein, before constructing the reference network, the method further comprises:
filtering the target users in the target user set according to a type of a to-be-obtained social relationship chain, a gender and an age of the center user, and genders and ages of the target users in the target user set.

19. The storage medium according to claim 18, wherein filtering the target users in the target user set comprises:
determining, according to the type of the to-be-obtained social relationship chain and the gender and age of the center user, a gender and an age range of a target user to be retained in the target user set; and
removing, from the target user set according to the determined gender and age range, a target user whose gender is different from the determined gender and a target user whose age is not within the age range.

20. The storage medium according to claim 17, wherein the determining, from the target user set according to the reference network, a target user being in a parent-child relationship chain with the center user comprises:
calculating damage values of the target users in the reference network, a damage value of a target user indicating a degree of damage to connectivity in the reference network when the target user is removed from the reference network; and
determining a target user having a maximum damage value as the target user being in a parent-child relationship chain with the center user.
